(19) United States
(12) Patent Application Publication
(10) Pub. No.: US 2010/0111698 A1
(43) Pub. Date: May 6, 2010

(54) Fan with locking ring

(76) Inventors: Bryce Wiedeman, Colts Neck, NJ (US); Phillip E. Thibodeau, Huntsville, AL (US)

Correspondence Address: WARD & OLIVO, SUITE 300, 382 SPRINGFIELD AVENUE, SUMMIT, NJ, 07901, US

(21) Appl. No.: 12/291,270

(22) Filed: Nov. 6, 2008

(51) Int. Cl. F04D 29/40; F04D 29/54; B23P 19/04; F04D 29/60

(52) U.S. Cl. 416/189; 415/228; 29/700; 416/244 R

(57) ABSTRACT

An airflow apparatus comprising a stator section, at least one stator blade and a plurality of mounting flanges disposed on the stator section is provided. Additionally, the airflow apparatus includes at least one slot disposed between the plurality of mounting flanges, a rotor assembly coupled to the at least one stator blade, whereby the rotor assembly has a proximal end and a distal end. Furthermore, the airflow apparatus includes at least one fan blade coupled to the rotor assembly. The airflow apparatus also includes a locking apparatus, whereby the locking apparatus includes at least one mounting member and at least one coupling member, wherein the at least one slot is coupled to the at least one coupling member.

### FIELD OF THE INVENTION

The present invention generally relates to the field of airflow devices and more specifically, to fans for moving air through a controlled space.

### BACKGROUND OF THE INVENTION

The use of fans to move air is well known. For example, fans are used to move air through heat exchangers in the field of air conditioning, the field of aircraft cooling and the field of motor vehicle cooling. A fan for such an application may consist of a hub member and a plurality of blade members, each blade member having a root portion and a tip portion. The root portions of each blade are secured to the hub portion such that the blades extend substantially radially from the hub portion. Additionally, a blade tip support ring placed near to, or more usually, at their tip portions may link the blades.

Such fans are often driven by an electric motor or via a transmission from an associated engine. The fans are usually disposed so that the fan's radial plane extends parallel to a face portion of the associated heat exchanger.

Furthermore, a typical goal in the manufacture of fans is a motor and fan assembly that is simple to manufacture and consequently has a low manufacturing cost. In AC motors for fans, the side armature AC motor comes closest to achieving these goals. However, DC motors for fans are being used more, particularly for fans used to cool electronics where DC power is available.

Many fans are complex in both their structure and their commutation circuitry. Where simple, low cost, and reliable fans with a rapid assembly process have been needed, these complex fans, which might more appropriately have been used, for example, in aircraft and shipboard applications, have been too expensive for the simple purpose of fan rotation.

Additionally, many methods have been used to attach and retain fans to equipment. These methods involve, to some degree, many pieces of loose hardware, which must be assembled and aligned in order to accept and hold the fan. In most cases, in order to maintain, repair, and/or replace the fan, the pieces of loose hardware must be removed. Thus, the probability of losing parts or reassembling parts incorrectly becomes dramatically increased. Furthermore, most cooling fans in aerospace applications are mounted via either “servo rings” or mounting “ears.” However, both methods require a vast quantity of loose hardware such as screws, nuts, washers, cams, etc. These mounting methods necessitate cumbersome, time-consuming, and mechanically involved assembly steps fraught with process uncertainty and unexpected variability.

Accordingly, a need exists for a fan that is of simple construction, and provides a simplified yet extremely rapid, consistent, and efficient assembly process for securing the fan to parent equipment. Additionally, a need exists for an efficient and reliable apparatus and method for securely attaching a fan to various types of parent equipment.

These and other desirable characteristics of the present invention will become apparent in light of the specification, drawings and claims.

### SUMMARY OF THE INVENTION

The present invention overcomes the various deficiencies associated with the prior art by creating a novel method and apparatus that is of unique construction and uses a unique mounting process, so that a user may mount a fan to a parent apparatus in a simple, efficient and reliable method.

In one object of the present invention, an airflow apparatus is provided to cool various types of user equipment.

In another object of the present invention, an airflow apparatus is provided that is of unique construction.

In yet another object of the present invention, an airflow apparatus is provided with a minimum number of parts necessary for coupling the airflow apparatus to a parent assembly.

Further, in another object of the present invention, an airflow apparatus and a locking apparatus are provided that simplifies the mounting process of the airflow apparatus to a parent assembly.

In yet another object of the present invention, an airflow apparatus and a locking apparatus are provided that allows a user to efficiently and reliably mount the airflow apparatus to a parent assembly.

In one aspect of the present invention, an airflow apparatus is provided comprising a stator section and at least one stator blade.

In another aspect of the present invention a plurality of mounting flanges disposed on the stator section are provided.

In yet another aspect of the present invention, at least one slot disposed between the plurality of mounting flanges is provided.

Further, in another aspect of the present invention, a rotor assembly is coupled to at least one stator blade, whereby the rotor assembly has a proximal end and a distal end.

In another aspect of the present invention, the airflow apparatus comprises at least one fan blade coupled to the rotor assembly.

In yet another aspect of the present invention, the airflow apparatus comprises a locking apparatus. The locking apparatus further includes at least one mounting member and at least one coupling member, wherein the at least one slot is coupled to the at least one coupling member.

Other objects, features, and characteristics of the present invention, as well as the methods of operation and functions of the related elements of the structure, and the combination of parts and economies of manufacture, will become more apparent upon consideration of the detailed description below, all of which form a part of this specification.

### BRIEF DESCRIPTION OF THE DRAWINGS

A further understanding of the present invention can be obtained by reference to preferred embodiments and corresponding alternate embodiments as set forth in the illustrations of the accompanying drawings. Although the illustrated embodiments are merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the specific methods and instrumentalities disclosed.

For a more complete understanding of the present invention, reference is now made to the following drawings in which:

FIG. 1 illustrates a perspective view of an airflow apparatus in accordance with the preferred embodiment of the present invention.

FIG. 2 illustrates top view of an airflow apparatus in accordance with the preferred embodiment of the present invention.

FIG. 3 illustrates a top view of a locking apparatus in accordance with the preferred embodiment of the present invention.

FIG. 4 illustrates a detailed top view of coupling member as shown in item 330 of FIG. 3 in accordance with the preferred embodiment of the present invention.

FIG. 5 illustrates a cross-sectional view of the locking apparatus along line A-A of FIG. 3 in accordance with the preferred embodiment of the present invention.

FIG. 6A illustrates a bottom perspective view of the airflow apparatus shown in FIG. 1 in proper alignment with the locking apparatus shown in FIG. 3 and a parent apparatus in accordance with the preferred embodiment of the present invention.

FIG. 6B illustrates a bottom perspective view of the airflow apparatus shown in FIG. 1 in engagement with the locking apparatus shown in FIG. 3 and a parent apparatus in accordance with the preferred embodiment of the present invention.

FIG. 6C illustrates a bottom view of the airflow apparatus shown in FIG. 1 in engagement with the locking apparatus shown in FIG. 3 and a parent apparatus in accordance with the preferred embodiment of the present invention.

FIG. 7 illustrates a top view of the airflow apparatus shown in FIG. 1 selectively coupled to a parent apparatus by means of the locking apparatus shown in FIG. 3 in accordance with the preferred embodiment of the present invention.

FIG. 8 is a flow chart illustrating a method of coupling the airflow apparatus of the present invention to a parent apparatus in accordance with the preferred embodiment of the present invention.

### DETAILED DESCRIPTION OF THE PREFERRED EMBODIMENTS

Detailed illustrative embodiments of the present invention are disclosed herein. However, techniques, systems, and operating structures in accordance with the present invention may be embodied in a wide variety of forms and modes, some of which may be quite different from those in the disclosed embodiments. Consequently, the specific structural and functional details disclosed herein are merely representative, yet in that regard, they are deemed to afford the best embodiments for the purposes of disclosure and to provide a basis for the claims herein, which define the scope of the present invention. The following presents a detailed description of preferred embodiments (as well as some alternative embodiments) of the present invention.

A further understanding of the present invention can be obtained by reference to a preferred embodiment. Although the illustrated embodiment is merely exemplary of systems for carrying out the present invention, both the organization and method of operation of the invention, in general, together with further objectives and advantages thereof, may be more easily understood by reference to the following description. The description is not intended to limit the scope of this invention, but merely to clarify and exemplify the invention.

Moreover, well known methods, procedures, and substances for both carrying out the objectives of the present invention and illustrating the preferred embodiment are incorporated herein but have not been described in detail as not to unnecessarily obscure novel aspects of the present invention.

Additionally, the use of the terms “parent equipment,” “using equipment,” “parent apparatus,” “parent assembly,” and the like are not meant to limit the scope of the present invention. Rather, the terms are used interchangeably and are meant to be merely illustrative in nature of certain aspects of the present invention. Additionally, the terms used herein, including “user”, “individual”, and “person” are not meant to limit the scope of the invention to one type of entity, as any entity or individual can also utilize the present invention.

Preferably, the airflow apparatus or fan of the present invention is designed for cooling electronics within, although not exclusively, the following types of parent equipment: aircrafts, ground-based and shipboard applications, and the like. Additionally, such electronics that may be cooled by the fan of the present invention include but are not limited to communications equipment, power supplies, avionics, radar, etc.

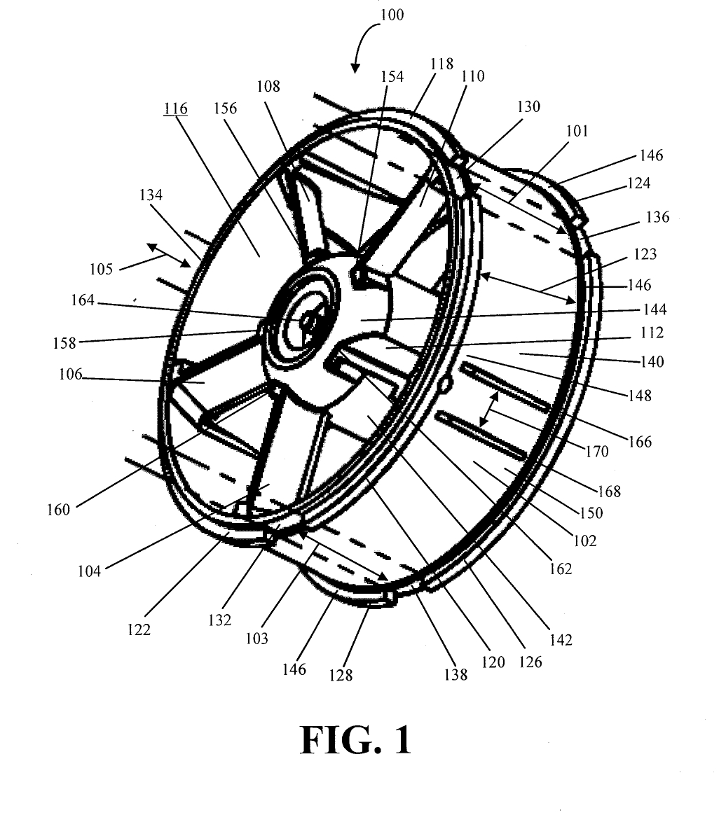

Referring to the figures, wherein like numerals indicate like elements throughout, FIG. 1 illustrates a perspective view of an airflow apparatus or fan assembly 100, preferably constructed of rigid material selected from the group of: steel, aluminum, titanium, and the like.

Generally, fan assembly 100 of FIG. 1 is collectively comprised of the following components: a stator section 102, a plurality of substantially similar stator blades 104, 106, 108, 110 and 112, a rotor assembly 142, a bottom hub 144, a top hub (not shown) and a plurality of fan blades (not shown).

Fan assembly 100 includes a stator section 102, which preferably serves as the fan housing or frame of fan assembly 100. Stator section 102 is generally cylindrical in shape and is preferably constructed of the same or similar material as fan assembly 100, such as steel, aluminum, titanium, and the like. However, any type of appropriate material may be used to construct stator section 102 without departing from the spirit of the present invention. Furthermore, fan assembly 100 is comprised of a plurality of substantially similar stator blades 104, 106, 108, 110 and 112, whereby each stator blade 104, 106, 108, 110 and 112 is preferably constructed of the same or similar material as stator section 102. More specifically, each stator blade 104, 106, 108, 110 and 112 is substantially similar and may be used interchangeably when describing the configuration and functionality thereof.

Importantly, a first end of each stator blade 104, 106, 108, 110 and 112 is preferably fixably coupled to stator section 102, while a second opposing end of each stator blade 104, 106, 108, 110 and 112 is fixably coupled to bottom hub 144, which forms the bottom portion of rotor assembly 142. Collectively, each stator blade 104, 106, 108, 110 and 112 is fixably coupled to bottom hub 144 in order to support bottom hub 144 and thus support rotor assembly 142. Bottom hub 144 is cup shaped and includes a plurality of equidistantly spaced grooves 154, 156, 158, 160 and 162 provided to receive opposing second end of each stator blade 104, 106, 108, 110 and 112. It should be appreciated that grooves 154, 156, 158, 160 and 162 may be spaced any distant apart from each other without departing from the spirit of the present invention. Preferably, bottom hub 144 is coupled to rotor assembly 142 via a traditional screw 164 as commonly known in the art. It should be appreciated that bottom hub 144 may be coupled to rotor assembly via screws, nuts, bolts, welded connection, press fit, snap fit or any other type of connection strategy or technique without limiting the scope of the present invention.

Furthermore, rotor assembly 142 houses a motor (not shown) and a bearing tower (not shown), whereby the bearing tower houses a set of bearings (not shown) and a shaft (not shown), each component is commonly known in the art. In operation, the motor is supplied with electric current via electrical coils, which excites rotor assembly 142 and causes rotor assembly 142 to rotate. This process may be performed in a variety of methods or techniques commonly known in the art without limiting the scope of the present invention.

Moreover, stator section 102 provides support to each stator blade 104, 106, 108, 110 and 112. Furthermore and as previously stated, fan assembly 100 may comprise at least one stator blade 104, however any amount of stator blades may be implemented in the design of fan assembly 100 without limiting the scope of the present invention. Preferably and as illustrated by FIG. 1, fan assembly 100 comprises five stator blades 104, 106, 108, 110 and 112. Each stator blade 104, 106, 108, 110 and 112 is arranged on a radial axis from bottom hub 144 and may be equidistantly spaced apart, thereby forming an airflow gap or aperture 116 between each stator blade 104, 106, 108, 110 and 112. It should be appreciated that stator blades 104, 106, 108, 110, and 112 may be spaced any distant apart from each other without departing from the spirit of the present invention. Aperture 116 preferably directs the flow of air through fan assembly 100 in order to discharge heat from parent apparatus (not shown).

Additionally, stator section 102 includes a plurality of extended flanges 166 and 168 located on exterior surface 140 of stator section 102. Preferably, extended flanges 166 and 168 serve to provide a slot 170, which is used to receive an attachment for holding electrical coils (not shown). Flanges 166 and 168 may also allow for traditional mounting methods to be used when required in a retrofit application.

Stator section 102 includes at least one mounting flange 118 fixably coupled to bottom edge 148 of stator section 102. Preferably, mounting flange 118 is generally a continuous ridge or protrusion that protrudes outwardly along the circumference of stator section 102 in a perpendicular direction from exterior surface 140.

Furthermore, stator section 102 preferably contains a plurality of substantially similar mounting flanges 118, 120 and 122, collectively referred to as the first set of mounting flanges, which is located along the bottom edge 148 of stator section 102. Each mounting flange 118, 120 and 122 is substantially similar and may be used interchangeably when describing the configuration and functionality thereof.

Stator section 102 contains a plurality of slots 130, 132 and 134 between mounting flange 118, 120 and 122 in accordance with the preferred embodiment of the present invention. Additionally, as illustrated by FIG. 1, stator section 102 preferably contains three slots 130, 132 and 134, which may be equidistantly spaced between mounting flanges 118, 120 and 122 (i.e. slot 130 is located between mounting flange 118 and 120, slot 132 is located between mounting flange 120 and 122 and slot 134 is located between mounting flange 118 and 122). It should be appreciated that slots 130, 132 and 134 may be spaced any distant apart from each other without departing from the spirit of the present invention. Furthermore, it is contemplated that any appropriate amount of slots may be implemented without limiting the scope of the present invention. Moreover, the slots of the present invention may be asymmetrically spaced so as to form a keying structure, wherein only the proper fan-type may be mounted to the parent assembly.

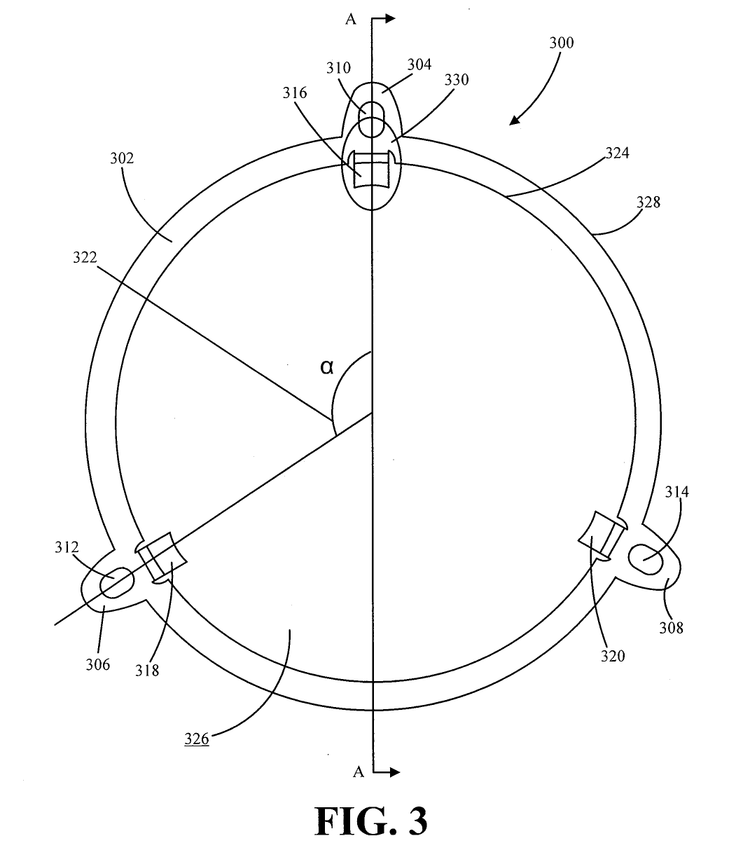

Importantly, each slot 130, 132 and 134 is substantially similar and may be used interchangeably when describing the configuration and functionality thereof. Each slot 130, 132 and 134 preferably exists on the bottom edge 148 of stator section 102 and is approximately the same width. Furthermore, each slot 130, 132, 134 of stator section 102 may slidingly engage coupling member or locking ring member of locking ring, which will be shown and described in FIG. 3, in order to selectively couple fan assembly 100 to parent apparatus (not shown). Additionally, the functionality of slots 130, 132, 134 will be thoroughly and extensively discussed below.

Moreover, fan assembly 100 preferably includes two sets of mounting flanges. However, it is contemplated that any appropriate amount of sets of mounting flanges may be implemented without limiting the scope of the present invention. The second set of mounting flanges preferably comprises a plurality of substantially similar mounting flanges 124, 126 and 128. Furthermore, each mounting flange 118, 120, 122, 124, 126 and 128 is substantially similar and may be used interchangeably when describing the configuration and functionality thereof. However, each mounting flange 124, 126 and 128 is fixably coupled along the top edge 150 of the perimeter of stator section 102 or along the opposite edge of stator section 102 as mounting flange 118, 120 and 122. Additionally, each mounting flange 124, 126 and 128 is constructed from the same or similar material and functions in the same or similar manner as mounting flange 118, 120 and 122. Furthermore, each mounting flange 124, 126 and 128 is preferably provided to add additional support to ensure fan assembly 100 is securely coupled to locking apparatus or locking ring, which will be shown in FIG. 3.

It should be appreciated that any amount of mounting flanges may be utilized without limiting the scope of the present invention.

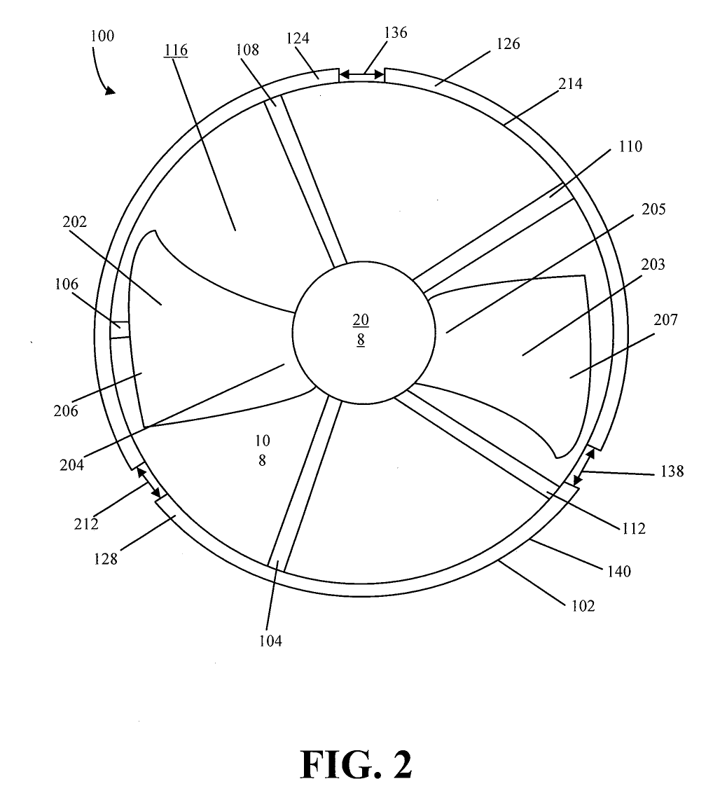

Additionally, as illustrated by FIG. 1, stator section 102 preferably comprises an additional set of slots, which includes slots 136, 138 and 212 as shown in FIG. 2, which may be equidistantly spaced between mounting flanges 124, 126 and 128 (i.e. slot 136 is located between mounting flange 124 and 126, slot 138 is located between mounting flange 126 and 128 and slot 212 of FIG. 2 is located between mounting flange 124 and 128). It should be appreciated that slots 136, 138 and 212 as shown in FIG. 2 may be spaced any distant apart from each other without departing from the spirit of the present invention. Furthermore, it is contemplated that any appropriate amount of slots 136, 138 and 212 as shown in FIG. 2 may be implemented without limiting the scope of the present invention. Importantly, each slot 130, 132, 134, 136, 138 and 212 as shown in FIG. 2 is substantially similar and may be used interchangeably when describing the configuration and functionality thereof. However, each slot 136, 138 and 212 as shown in FIG. 2 exists along the top edge 150 of the perimeter of stator section 102.

As shown by FIG. 1, slot 130 is aligned along vertical axis 101 with substantially similar slot 136, whereby slot 130 and slot 136 are substantially the same width and are spaced apart by approximately depth 123 of stator section 102. Additionally, slot 132 is aligned along vertical axis 103 with substantially similar slot 138, whereby slot 132 and slot 138 are substantially the same width and are spaced apart by approximately depth 123 of stator section 102. Moreover, slot 134 is aligned along vertical axis 105 with substantially similar slot 212, which is shown in FIG. 2, whereby slot 134 and slot 212 are substantially the same width and are spaced apart by approximately depth 123 of stator section 102.

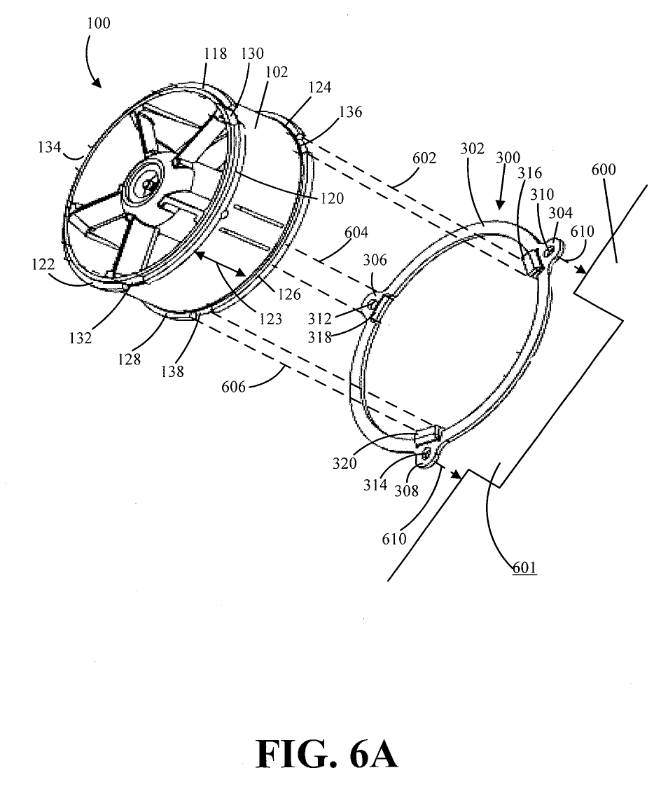

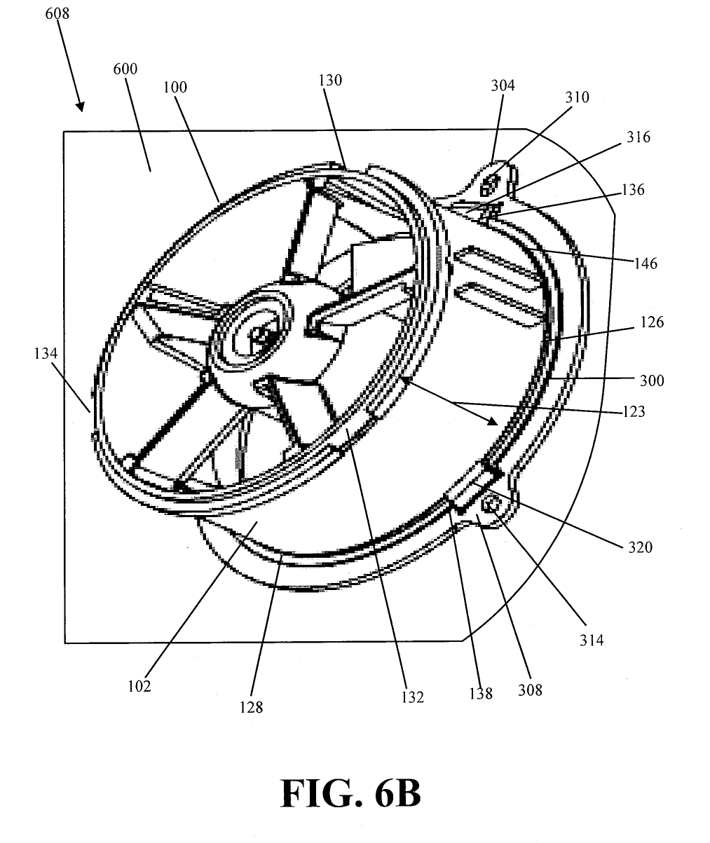

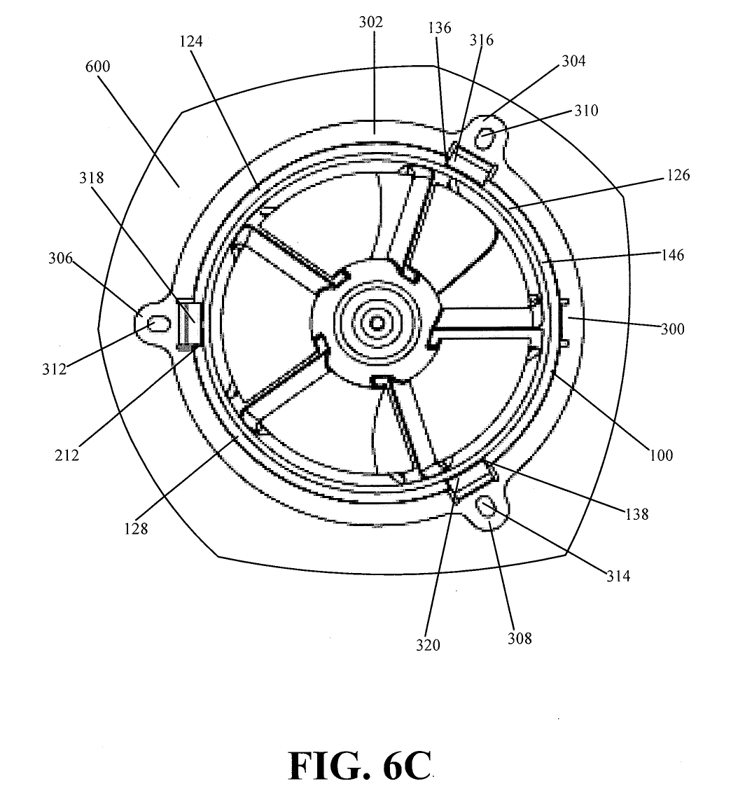

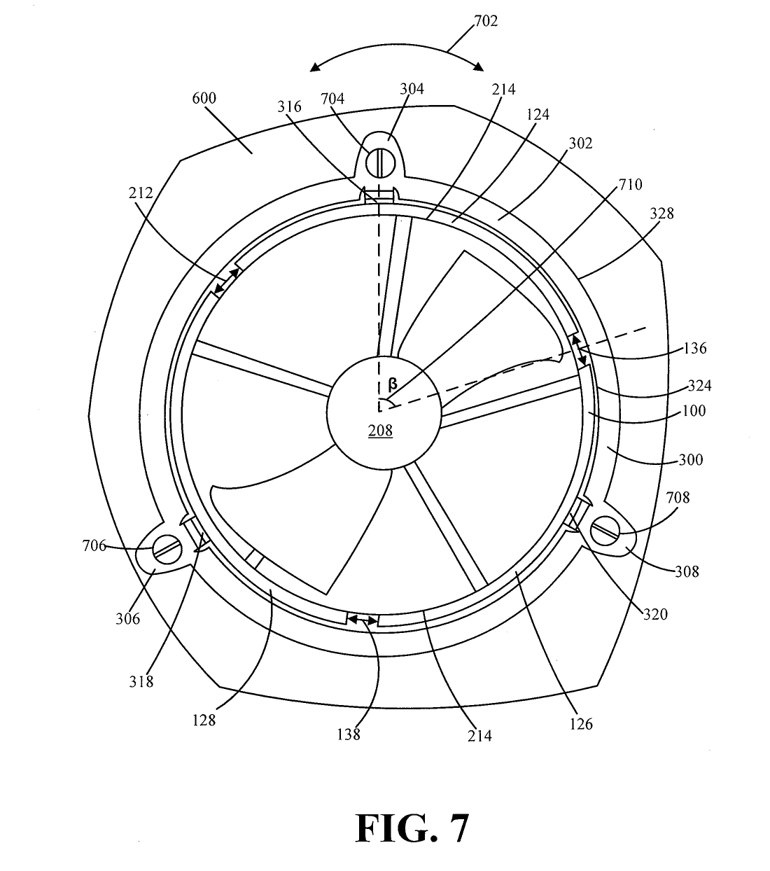

Furthermore, each slot 136, 138, and 212 as shown in FIG. 2 of stator section 102 may slidingly engage coupling member or locking ring member of locking ring, which will be shown and described in FIG. 3, in order to selectively couple fan assembly 100 to parent apparatus (not shown), which will be shown and described in FIGS. 6A-6C and 7. Additionally, the functionality of slots 136, 138, 212 as shown in FIG. 2 will be thoroughly and extensively discussed below.

It will be apparent to those of skill in the art that numerous changes may be made in such details without departing from the spirit and the principles of the present invention. It should be appreciated that the present invention is capable of being embodied in other forms without departing from its essential characteristics.

Each mounting flange 118, 120, 122, 124, 126 and 128 of fan assembly 100 provides a convenient, rapid, and efficient method to securely couple fan assembly 100 to parent apparatus (not shown). Additionally, fan assembly 100 of the present invention can preferably reduce and/or eliminate several loose hardware components as well as cumbersome, time-consuming and mechanically involved assembly steps, which are fraught with process uncertainty and unexpected variability. Thus, the present invention preferably serves to increase efficiency and reliability with regards to a user selectively coupling fan assembly 100 to parent apparatus (not shown).

Additionally, each mounting flange 118, 120, 122, 124, 126 and 128 of the present invention cooperates with a plurality of slots 130, 132, 134, 136, 138 and 212 as shown FIG. 2 allowing users to selectively couple fan assembly 100 to parent apparatus (not shown). This enables the user to efficiently couple fan assembly 100 to parent apparatus (not shown) in a rapid and simple manner. This is especially useful when a plurality of fan assemblies 100 are to be coupled to a plurality of separate sections of parent equipment and/or different parent equipment such as in an assembly line whereby thousands of parent apparatuses are manufactured.

Thus, each mounting flange 118, 120, 122, 124, 126 and 128 of the present invention provides users with an advantage, namely enabling users to efficiently and securely couple fan assembly 100 to parent apparatus (not shown), as will be described below.

Referring now to FIG. 2, illustrated is a top view of airflow apparatus 100 in accordance with the preferred embodiment of the present invention. Located at the opposing end of rotor assembly 142 as shown in FIG. 1 is top hub 208, which may be selectively coupled to rotor assembly 142 as shown in FIG. 1 via screws, nuts, bolts, fasteners, welded connection, press fit, snap fit or any other type of connection strategy or technique, as commonly known in the art. However, any method of coupling a hub to a bearing tower may be implemented without departing from the spirit of the present invention. Furthermore and as previously mentioned, fan assembly 100 includes a plurality of substantially similar fan blades 202 and 203, although in other non-limiting embodiments, any number of fan blades may be utilized without departing from the scope of the present invention. Each fan blade 202 and 203 is substantially similar and may be used interchangeably when describing configuration and functionality thereof. Preferably, root regions 204 and 205 of each fan blade 202 and 203 is fixably coupled to top hub 208 of fan assembly 100 so that each fan blade 202 and 203 extends substantially radially of the rotational axis of rotor assembly 142, whereby distal ends 206 and 207 of each fan blade 202 and 203 are in close proximity to interior surface 214 of stator section 102.

Furthermore, fan assembly 100 as well as each component, particularly although hot exclusively stator section 102, stator blades 104, 106, 108, 110 and 112, top hub 208, fan blades 202 and 203, mounting flanges 118, 120, 122, 124, 126 and 128, rotor assembly 142, and bottom hub 144 is preferably constructed from and consist of the same rigid material. Preferably, the rigid material may be steel, aluminum, titanium, and the like.

FIG. 3 depicts a top view of a locking apparatus or locking ring 300 in accordance with the preferred embodiment of the present invention along with its pertinent components. Particularly, although not exclusively, locking ring 300 comprises of a generally cylindrical locking ring assembly 302, at least one mounting member 304, at least one coupling member or locking ring member 316 and an opening 326. In a preferred embodiment of the present invention, locking ring 300 as well as each component, particularly although not exclusively, locking ring assembly 302, mounting member 304, and locking ring member 316 is preferably constructed from and consist of the same rigid material. Preferably, the rigid material may be steel, aluminum, titanium, and the like.

Furthermore, in a preferred embodiment of the present invention, mounting member 304 is fixably coupled to locking ring assembly 302, whereby mounting member 304 protrudes outwardly from external perimeter 328 of locking ring assembly 302. Additionally, locking ring assembly preferably comprises a plurality of mounting members 304, 306, 308, whereby each mounting member 304, 306 and 308 is substantially similar and may be used interchangeably when describing the configuration and functionality thereof. Preferably, each mounting member 304, 306 and 308 contains a respective aperture 310, 312 and 314 for securing locking ring 300 to parent apparatus (not shown).

Preferably, each mounting member 304, 306 and 308 is fixably coupled and equally spaced apart along external perimeter 328 of locking ring assembly 302 so as to allow a user to securely and selectively couple locking ring 300 to parent apparatus (not shown). As illustrated by FIG. 3, the preferred embodiment of the present invention includes three mounting members 304, 306 and 308. Therefore, each mounting member 304, 306 and 308 is inherently spaced apart by an angle alpha (α) 322, which is approximately 120 degrees. However, it is contemplated that any amount of mounting members may be implemented in the design of locking ring 300 without limiting the scope of the present invention.

Additionally, in a preferred embodiment of the present invention, locking ring 300 includes at least one coupling member or locking ring member 316, which is fixably coupled to internal perimeter 324 of locking ring assembly 302. Additionally, locking ring member 316 protrudes inwardly from internal perimeter 324 of locking ring assembly 302. Preferably, a plurality of locking ring members 316, 318 and 320 are fixably coupled and equally spaced apart along internal perimeter 324 of locking ring assembly 302 so as to allow a user to securely and selectively couple fan assembly 100 to locking ring 300, which in turn allows the user to couple fan assembly 100 to parent apparatus (not shown).

As previously mentioned, locking ring 300 includes three locking ring members 316, 318 and 320, whereby each locking ring member 316, 318 and 320 may be located in close proximity to each respective mounting member 304, 306 and 308. Therefore, locking ring members 316, 318 and 320 are inherently spaced apart by an angle alpha (α) 322, which is approximately 120 degrees. Conversely, it is contemplated that any amount of locking ring members 316, 318 and 320 may be implemented in the design of locking ring 300 without limiting the scope of the present invention. Furthermore, in order to selectively couple fan assembly 100 to locking ring 300, which will be extensively and thoroughly described below with regards to FIGS. 6A-6C and 7, each locking ring member 316, 318 and 320 selectively and slidably engages with each respective slot 136, 138 and 212 located between each respective mounting flange 124, 126 and 128, whereby each locking ring member 316, 318 and 320 continues past each respective slot 136, 138 and 212 along depth 123 of stator section 102 until each locking ring member 316, 318 and 320 rests just above each respective slot 136, 138 and 212.

In the preferred embodiment, locking ring assembly 302 encloses an opening 326 (i.e. an aperture, which provides a space for selectively accepting fan assembly 100). Preferably, a user may selectively engage and place fan assembly 100 within opening 326 so that fan assembly 100 may be coupled to locking ring 300.

In operation, each locking ring member 316, 318 and 320 provides an efficient and secure method for selectively coupling fan assembly 100 to locking ring 300 and in turn to parent apparatus (not shown), which will be shown and described in FIGS. 6A-6C and 7.

Additionally, the device of the present invention could include a fourth locking ring member on locking ring 300 and a corresponding fourth slot on fan assembly 100 so as to form a key, which allows only the proper fan to be assembled to the parent apparatus.

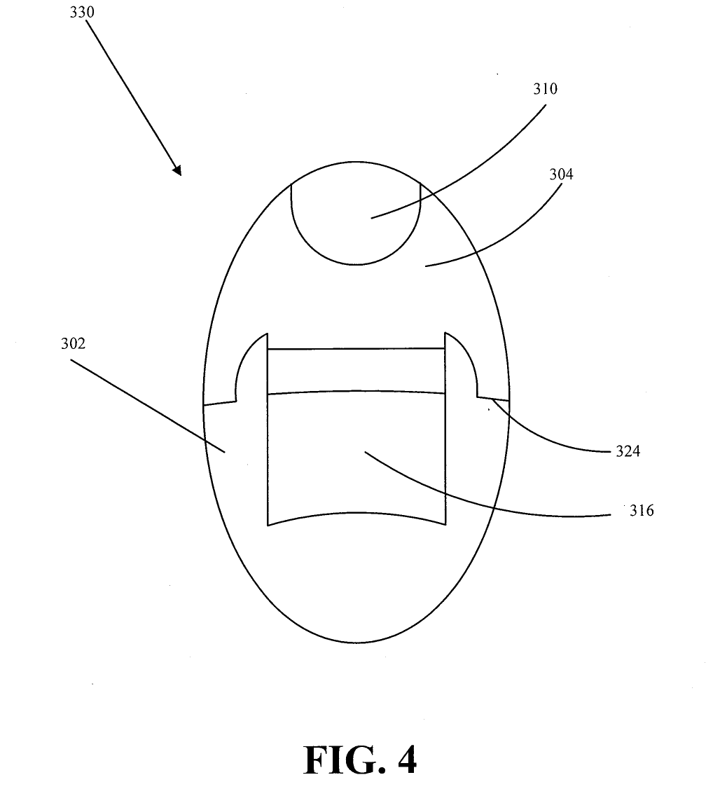

Referring to FIG. 4, there is shown a top view of locking ring member 316 as shown in item 330 of FIG. 3. More importantly, locking ring member 316 preferably extends outwardly from internal perimeter 324 of locking ring assembly 302 so as to be able to selectively and slidably engage with slot 136 and rest just above slot 136 as shown in FIG. 1. Additionally, from FIG. 4 it can be seen that locking ring member 316 is in close proximity to mounting member 304 and aperture 310.

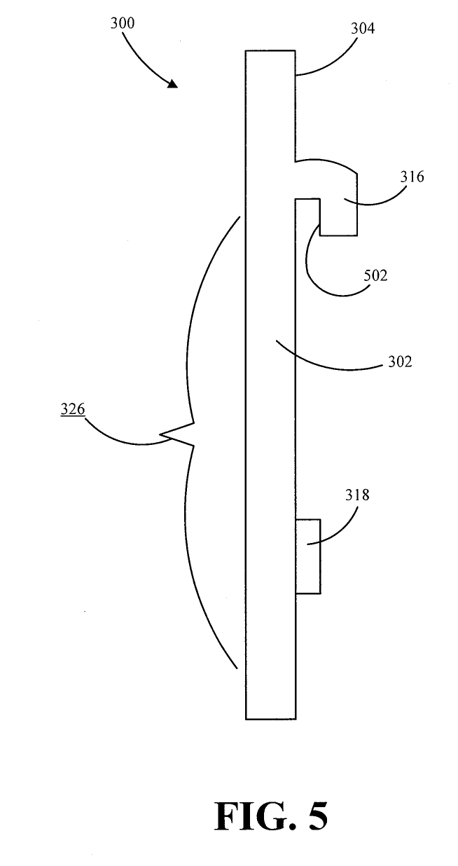

FIG. 5 illustrates a cross-sectional view of locking apparatus 300 along line A-A of FIG. 3. Specifically, FIG. 5 illustrates a cross-sectional view of locking ring 300 along line A-A, whereby locking ring member 316 is shown to be slightly elevated from locking ring assembly 302. Additionally, locking ring member 316 is shown to be extending out from internal perimeter 324 and into opening 326. As illustrated by FIG. 5, locking ring member 316 includes underside surface 502. Underside surface 502 of locking ring member 316 preferably serves to engage with underside surface 146 of mounting flanges 124, 126 and 128 as illustrated in FIG. 1. Although only the underside of one locking ring member has been explicitly shown in detail, it should be understood that each locking ring member 316, 318 and 320 includes an underside surface, whereby each underside surface serves to engage each underside surface 146 of each respective mounting flange 124, 126 and 128 as shown in FIG. 1 in order to selectively couple fan assembly 100 of FIG. 1 to locking ring 300 of FIG. 2.

It will be apparent to those of skill in the art that numerous changes may be made in such details without departing from the spirit and the principles of the present invention. It should be appreciated that the present invention is capable of being embodied in other forms without departing from its essential characteristics.

In operation, and as shown in FIGS. 6A-6C locking ring members 316, 318 and 320 are coupled to stator section 102 in order to couple airflow apparatus 100 to parent apparatus 600. Specifically and as shown in FIG. 6A, locking ring 300 is aligned with parent apparatus 600, whereby each aperture 310, 312 and 314 of locking ring 300 is aligned to each corresponding mating element or aperture (not shown) of parent apparatus 600. Once each aperture 310, 312 and 314 has been properly aligned with parent apparatus 600, locking ring 300 follows the arrows of engagement path 610 and is placed on the surface of parent apparatus 600. Once locking ring 300 is engaged with parent apparatus 600, a user may secure fasteners (not shown) through apertures 308, 310 and 312 onto parent apparatus 600. Additionally, FIG. 6A illustrates cavity 601 of parent apparatus 600, whereupon fan assembly 100 resides after coupling fan assembly 100 with parent apparatus 600.

Once locking ring 300 is securely coupled to parent apparatus 600, fan assembly 100 may now engage locking ring 300. Thus, fan assembly 100 is aligned so that each locking ring member 316, 318 and 320 is aligned with each respective slot 130, 132, 134, 136, 138 and 212 as was shown in FIG. 2 of fan assembly 100, whereby locking ring member 316 is aligned with slots 130 and 136, locking ring member 318 is aligned with slots 132 and 138, and locking ring member 320 is aligned with slots 134 and 212. Furthermore, engagement paths 602, 604 and 606 illustrate the path each slot 136, 212 and 138 will travel as each locking ring member 316, 318 and 320 slidably engages each respective slot 136, 138 and 212 of fan assembly 100.

As shown in FIG. 6B, locking ring 300 is coupled to parent apparatus 600 and fan assembly 100 is coupled to locking ring 300. Preferably, top planar surface of fan assembly 100 is placed in alignment with locking ring 300, whereby each slot 136, 138 and 212 is aligned with each corresponding locking ring member 316, 318 and 320. Once each slot 136, 138 and 212 is aligned with each locking ring member 316, 318 and 320, fan assembly 100 slidably engages locking ring 300, whereby fan 100 enters opening 326 as was shown in FIG. 3. As fan assembly 100 proceeds into opening 326 as was shown in FIG. 3 of locking ring 300, each locking ring member 316, 318 and 320 slidably engages each respective slot 136, 138 and 212. Fan assembly 100 continues down through opening 326 and into cavity 601, whereby each locking ring member 316, 318 and 320 slides along the depth 123 of fan assembly 100 and proceeds to rest just above each respective slot 136, 138 and 212 as was shown in FIG. 2. Preferably, fan assembly 100 continues to slide through opening 326 and into cavity 601 until each locking ring member 316, 318 and 320 rests just above each slot 136, 138 and 212 as was shown in FIG. 2. Furthermore, although the process of selectively coupling fan assembly 100 to locking ring 300 was described with the inclusion of more than one arrangement of locking ring members 316, 318 and 320 and slots 136, 138 and 212 as was shown in FIG. 2, one arrangement or a plurality of arrangements may be implemented in the design without limiting the scope of the present invention.

Preferably, fan assembly 100 couples to locking, ring 300 so that the direction of airflow 608 flows from the bottom of fan assembly 100 and out through the top of fan assembly 100 [Is this accurate?].

FIG. 6C is simply an alternate view of FIG. 6B. As described above with regards to FIG. 3, locking ring 300 preferably consists of locking ring assembly 302, which contains a plurality of mounting members 304, 306 and 308 with respective apertures 310, 312 and 314 and a plurality of locking ring members 316, 318 and 320.

Preferably and as described above, top planar surface of fan assembly 100 is placed in alignment with locking ring 300, whereby each slot 136, 138 and 212 is aligned with each corresponding locking ring member 316, 318 and 320. Once each slot 130, 132 and 134 is aligned with each locking ring member 316, 318 and 320, fan assembly 100 slidably engages locking ring 300, whereby fan assembly 100 enters opening 326 as was shown in FIG. 3. As fan assembly 100 proceeds into opening 326 as shown in FIG. 3 of locking ring 300, each locking ring member 316, 318 and 320 slidably engages each respective slot 136, 138 and 212. Fan assembly 100 continues down through opening 326 and into cavity 601 of parent apparatus 600, whereby each locking ring member 316, 318 and 320 slides along the depth 123 of fan assembly 100 and proceeds to rest just above each respective slot 136, 138 and 212 as was shown in FIG. 2. Preferably, fan assembly 100 continues to slide through opening 326 and into cavity 601 until each locking ring member 316, 318 and 320 rests just above each slot 136, 138 and 212 as was shown in FIG. 2.

Turning now to FIG. 7, illustrated is a top view of airflow apparatus 100 selectively coupled to the locking apparatus 300, whereby locking ring 300 is engaged with and coupled to parent apparatus 600. As discussed above, in order to securely couple locking ring 300 to parent apparatus 600, each aperture 310, 312 and 314 as was shown in FIG. 3 of locking ring 300 should be aligned to each corresponding mating element or aperture (not shown) of parent apparatus 600. Generally, any type of mating element or aperture commonly known in the art may be implemented without limiting the scope of the invention. Once aligned the user engages each respective aperture 310, 312 and 314 with any appropriate type of the fastening member 704, 706 and 708 commonly known in the art, as shown in FIG. 7. Such fastening members 704, 706 and 708 may include screws, nuts, bolts, fasteners, welded connection, or any other type of connection strategy or technique. Once a user aligns each aperture 310, 312 and 314 with each aperture or mating element (not shown) of parent apparatus 600 and engages each aperture 310, 312 and 314 with each respective fastening member 704, 706 and 708, the user may proceed to tighten fastening members 704, 706 and 708 aperture tightens each fastening member 704, 706 and 708 so that each fastening member 704, 706 and 708 continues through each corresponding aperture 310, 312 and 314 as to securely couple locking ring 300 to parent apparatus 600. Once locking ring 300 is securely coupled to parent apparatus 600 via fastening members 704, 706 and 708, locking ring 300 preferably does not have to be removed from parent apparatus 600, even for fan repairs or for a complete fan replacement.

Furthermore, FIG. 7 illustrates how fan assembly 100 is selectively coupled to locking ring 300, which in turn selectively couples fan assembly 100 to parent apparatus 600. Once fan assembly 100 is properly positioned within parent apparatus 600, whereby each locking ring member 316, 318 and 320 has completely slid above each respective slot 136, 138 and 212 as described above, fan assembly 100 is prepared to be securely coupled to locking ring 300. Preferably, once fan assembly 100 is properly positioned within parent apparatus 600, fan assembly 100 is rotated in either direction 702 by an angle beta (β) 710. Additionally, fan 100 may be rotated any appropriate angle in order to securely couple airflow apparatus 100 to parent apparatus 600, without limiting the scope of the present invention. As previously stated, fan assembly 100 may be rotated in either direction 702 without departing from the spirit of the present invention.

As fan assembly 100 is rotated, each locking ring member 316, 318 and 320 slides below each respective mounting flange 124, 128 and 126, whereby underside surface 146 as was shown in FIG. 1 of each mounting flange 124, 128, and 126 securely engages underside surface 502 as was shown in FIG. 5 of each locking ring member 316, 318 and 320. Thus, each locking ring member 316, 318 and 320 assists in securely retaining fan assembly 100 in place so that fan assembly 100 may be selectively and securely coupled to parent apparatus 600. Once fan assembly 100 is rotated, each fastening member 704, 706 and 708 is once again tightened to ensure that fan assembly 100 is securely coupled to parent apparatus 600. Importantly, locking ring 300 is designed and dimensioned such that force is applied to each mounting flange 124, 128 and 126 by each corresponding mounting member 304, 306 and 308 of locking ring 300 by tightening fastening members 704, 706 and 708.

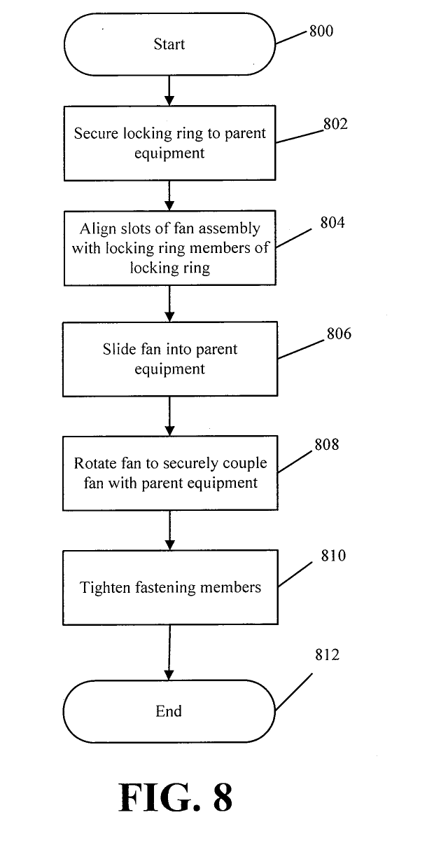

FIG. 8 is a flow chart depicting a method of coupling fan assembly 100 of the present invention to any one of a wide array of parent apparatuses in accordance with the preferred embodiment of the present invention. The method starts in step 800 and proceeds to step 802, whereby a user securely couples locking ring 300 to parent apparatus 600 by first aligning each aperture 310, 312 and 314 corresponding with each mounting member 304, 306 and 308 with each mating member or aperture (not shown) of parent apparatus 600. Once aligned, the user then tightens each respective fastening member 704, 706, and 708 so as to securely couple locking ring 300 to parent apparatus 600. In step 804, the user aligns each slot 136, 138 and 212 of top edge 150 of stator section 102, with each locking ring member 316, 318 and 320 of locking ring 300.

Upon aligning each slot 136, 138 and 212 with each locking ring member 316, 318 and 320 of locking ring 300, the user may then engage each slot 136, 138 and 212 with each locking ring member 316, 318 and 320 by sliding fan assembly 100 into opening 326 in step 806. Preferably, the user continues to slide fan assembly 100 so that fan assembly 100 becomes properly positioned within cavity 601 of parent apparatus 600. While the user is sliding fan assembly 100 into parent apparatus 600, each locking ring member 316, 318 and 320 continues to slide along the depth 123 of fan assembly 100 until each locking ring member 316, 318 and 320 rests just above slots 136, 138 and 212, thereby properly positioning fan assembly 100 within cavity 601 of parent apparatus 600.

Once fan assembly 100 is properly positioned within parent apparatus 600, the user then rotates fan assembly 100 in either direction 702 in order to securely couple fan assembly 100 to parent apparatus 600 in step 808. In step 810, the user tightens each fastening member 704, 706 and 708 thereby applying a force to each corresponding mounting flange 124, 128 and 126 by mounting members 304, 306 and 308 of locking ring 300, which ensures that fan assembly 100 is securely coupled to parent apparatus 600. The process ends in step 812, whereby fan assembly 100 is securely coupled to parent apparatus 600 in an extremely rapid, efficient, and consistent assembly process. Conversely, a user may choose to utilize a variety of different methods with a similar device. Thus, the above method serves only to illustrate an exemplary method and should not limit the scope of the invention, as the scope of the invention is limited solely by the claims.

In one embodiment, the present invention comprises an apparatus for selectively and securely coupling to the parent equipment. Preferably, the apparatus of the present invention further comprises a plurality of mounting members for selectively and securely coupling the apparatus to the parent equipment. The apparatus is further capable of engaging with a mounting flange fixably coupled to a stator section of a fan assembly of the present invention for rapid, efficient, and secure coupling of the fan to the parent equipment.

It is contemplated that the system of the present invention may be modified and embodied in several different fashions in adhering to the needs of a given user without departing from the spirit thereof. It will be apparent to those of skill in the art that numerous changes may be made in such details without departing from the spirit and the principles of the present invention. It should be appreciated that the present invention is capable of being embodied in other forms without departing from its essential characteristics.

Importantly, the present invention contains a locking ring, a plurality of slots and a plurality of mounting flanges to enable the airflow apparatus of the present invention to be securely coupled to various types of parent equipment.

In one embodiment, the system of the present invention is preferably comprised of a fan assembly, which comprises a stator section (i.e. the fan housing), a bearing tower, whereby the bearing tower is preferably composed of a single piece into which the bearings and the preloaded spring are assembled, a plurality of fan blades for releasing or discharging heat from the parent apparatus, which are collectively coupled to a hub that is attached to one end of the bearing tower, a plurality of stator blades for directing the flow of air, which are collectively coupled to a hub that is attached to the opposing end of the bearing tower, and a plurality of mounting flanges. Additionally, the system of the present invention comprises a locking ring, whereby the mounting flange of the fan assembly interconnects with and couples to the locking ring for coupling the fan to a specific parent apparatus. Each component forms an integral part of the airflow apparatus so as to achieve higher aerodynamic performance and efficiency while minimizing acoustic noise. Preferably, the housing of the fan, the fan blades, the stator blades, and the bearing tower are constructed from rigid material that is meant to resist bending and/or breaking.

Each stator blade extends from the hub and connects to the housing of the fan. Additionally, each stator blade is generally straight, thus each stator blade preferably remains the same length from the hub to the stator section or fan housing. Additionally, the stator blades of the present invention serve not only to direct the flow of air through the fan assembly, but also to support the bearing tower upon which the fan blades are attached.

The locking ring, also referred to as a mounting ring of the present invention, preferably features three mounting members that protrude outwardly from the locking ring. Each mounting member accepts a fastening member for securing the locking ring to the parent or user equipment. Additionally, the stator section comprises at least one mounting flange, which is generally a continuous ridge or protrusion along the circumference of the stator section (i.e. fan housing). Preferably, stator section includes at least one slot or opening spaced throughout the external surface of the stator section.

The locking ring is initially secured to the parent assembly by selectively coupling each mounting member to the parent assembly via the use of fastening members. Opposite each mounting member is a locking ring member. The locking ring members engage the mounting flange of the fan through the slots formed in the stator section. Preferably, the fan is then rotated so that each locking ring member is engaged to each respective mounting flange, whereupon the fastening members securing the locking ring to the parent assembly are tightened in order to securely mount the fan to the parent assembly. This mounting method minimizes the number of loose hardware pieces as well as simplifies the mounting process.

Thus, the present invention provides a fan assembly, which includes at least one mounting flange and a locking ring and is able to conveniently and securely couple to parent equipment all while successfully improving the efficiency and the reliability of the assembly process.

Furthermore, the fan of the present invention may be easily detachable from the parent equipment, thus allowing an individual to efficiently remove a broken fan for repairs without having to disassemble the entire fan assembly. The present invention is also useful for completely replacing worn out and/or broken fans in an efficient and reliable assembly process.

In yet another embodiment, the present invention may be comprised of an apparatus, which can be fastened to the parent equipment in order to allow for reliable and efficient coupling of the fan of the present invention to the parent assembly.

Importantly, while the present invention has been discussed herein with respect to various embodiments several notable features of the present invention are shown in the preferred illustrative embodiment. The present invention is used for enabling an individual to selectively couple a fan to various types of parent equipment. In the preferred embodiment, the present invention provides an apparatus comprising a fan, whereby the fan includes a stator assembly, at least one mounting flange, wherein the mounting flange comprises at least one slot; and a locking ring, the locking ring includes at least one mounting member, and at least one locking ring member. The locking ring is selectively coupled to a parent apparatus by applying and tightening at least one fastening member to the at least one mounting member, thereby selectively coupling the locking ring to the parent apparatus. Additionally, the fan is selectively coupled to the parent assembly by aligning and engaging the at least one slot with the at least one locking ring member, sliding the fan into parent apparatus, and subsequently rotating the fan, whereby the at least one locking ring member securely engages the mounting flange, and whereupon the at least one fastening member is once again tightened to the parent assembly. Furthermore, the present invention is configured to couple a fan to a variety of parent apparatuses in an effort to successfully increase the efficiency and reliability of the assembly process.

Moreover, the fan of the present invention is designed for cooling electronics in aircrafts and ground-based and shipboard applications. Such electronics that may be cooled by the fan of the present invention, particularly although not exclusively, include communications equipment, power supplies, avionics and radar.

While the present invention has been described with reference to the key features, preferred embodiment and alternative embodiments, which embodiments have been set forth in considerable detail for the purposes of making a complete disclosure of the invention, such embodiments are merely exemplary and are not intended to be limiting or represent an exhaustive enumeration of all aspects of the invention. Thus, the scope of the invention shall be defined solely by the following claims.

It will be appreciated by those skilled in the art that changes can be made to the embodiments described above without departing from the broad inventive concept thereof. It is understood, therefore, that this invention is not limited to the particular embodiments disclosed, but it is intended to cover all modifications that are within the scope and spirit of the invention as defined by the appended claims.

What is claimed is:

1. An airflow apparatus comprising:
a stator section and at least one stator blade;
a plurality of mounting flanges disposed on said stator section;
at least one slot disposed between said plurality of mounting flanges;
a rotor assembly coupled to said at least one stator blade, said rotor assembly having a proximal end and a distal end; and
at least one fan blade coupled to said rotor assembly;
a locking apparatus, further having at least one mounting member and at least one coupling member, wherein said at least one slot is coupled to said at least one coupling member.

2. The apparatus according to claim 1 wherein said stator section defines an air passage.

3. The apparatus according to claim 1 wherein said at least one mounting member is coupled to a parent apparatus.

4. The apparatus according to claim 3 wherein said at least one mounting member includes an aperture.

5. The apparatus according to claim 4 further comprising a fastening member, wherein said fastening member is coupled to said aperture, said fastening member being further coupled to said parent apparatus, thereby coupling said locking apparatus to said parent apparatus.

6. The apparatus according to claim 1 wherein said plurality of mounting flanges protrude outward along the circumference of said stator section.

7. The apparatus according to claim 1 wherein said plurality of mounting flanges are coupled to said at least one coupling member.

8. The apparatus according to claim 1 wherein said at least one stator blade having a first end and an opposed second end, said first end coupled to said stator section.

9. The apparatus according to claim 8 wherein said opposed second end of said at least one stator blade is coupled to a hub of said rotor assembly.

10. The apparatus according to claim 8 wherein said at least one fan blade is coupled to opposing distal end of said rotor assembly.

11. The apparatus according to claim 1 wherein said airflow apparatus is constructed from a rigid material.

12. An apparatus comprising:
a locking assembly;
at least one mounting member disposed on said locking assembly, wherein said at least one mounting member having at least one aperture;
at least one coupling member disposed on said locking assembly;
an opening disposed within said locking assembly for receiving an airflow apparatus, wherein said airflow apparatus is attached to said apparatus.

13. The apparatus according to claim 12 wherein said at least one mounting member protrudes outward from said locking assembly.

14. The apparatus according to claim 12 wherein said at least one coupling member protrudes inward from said locking assembly.

15. The apparatus according to claim 12 wherein said locking assembly is in the shape of a ring, thereby defining said opening.

16. A method for coupling an airflow apparatus having flanges disposed on a portion thereof to a locking apparatus having at least one coupling member, the method comprising:
aligning at least one coupling member of the locking apparatus to an opening in the flange;
engaging the at least one opening of the airflow apparatus with the at least one coupling member of the locking apparatus; and
rotating the airflow apparatus about the locking apparatus, thereby engaging at least one of the plurality of mounting flanges with the at least one coupling member.

17. The method of claim 16 wherein the locking apparatus is coupled to a parent apparatus.

18. The method of claim 17 wherein the parent apparatus is electronic equipment disposed within one of the following: aircrafts, ground-based or shipboard apparatuses.

19. The method of claim 18 wherein the electronic equipment is selected from the group consisting of communications equipment, power supplies, avionics and radar.

20. The method of claim 17 wherein the air flow apparatus is constructed from a rigid material.
